(19) United States
(12) Patent Application Publication
(10) Pub. No.: US 2025/0371842 A1
(43) Pub. Date: Dec. 4, 2025

(54) METHOD, APPARATUS, DEVICE AND STORAGE MEDIUM FOR OBJECT RECOGNITION

(71) Applicant: Beijing Youzhuju Network Technology Co., Ltd., Beijing (CN)

(72) Inventors: Baoming Yan, Beijing (CN); Bo Gao, Beijing (CN); Jiana Yang, Beijing (CN); Xiaomeng Liu, Beijing (CN); Yang Xiang, Beijing (CN)

(21) Appl. No.: 19/223,632

(22) Filed: May 30, 2025

(30) Foreign Application Priority Data
May 31, 2024 (CN) 202410696398.0

(51) Int. Cl. G06V 10/75; G06V 10/10; G06V 10/25; G06V 10/44; G06V 10/74; G06V 10/774; G06V 10/98; G06V 30/18; G06V 30/19

(52) U.S. Cl. CPC G06V 10/759; G06V 10/16; G06V 10/25; G06V 10/44; G06V 10/761; G06V 10/7747; G06V 10/993; G06V 30/18; G06V 30/19093; G06V 30/19147

(57) ABSTRACT

The embodiment of the disclosure provides a method, apparatus, device, and storage medium for object recognition. The method includes: determining a set of first candidate object regions based on image information of a media content; determining, based on text information associated with the media content, an object region from the set of first candidate object regions; and determining an object matching the object region based on a visual feature of the object region and a text feature, the text feature being determined based on the text information. Based on the manner, disclosure may recognize an object in the media content for multimodal information of the image information of the media content and text information associated with the media content, which may effectively improve the accuracy of the object recognition.

### CROSS-REFERENCE

This application claims priority to Chinese patent application No. 202410696398.0, filed on May 31, 2024 and entitled ‘METHOD, APPARATUS, DEVICE AND STORAGE MEDIUM FOR OBJECT RECOGNITION’, which is incorporated herein by reference in its entirety.

### FIELD

Example embodiments of the present disclosure generally relate to the field of computers, and in particular, to a method, apparatus, device, and computer-readable storage medium for object recognition.

### BACKGROUND

With the rapid development of intelligence, various forms of media content devices may greatly enrich people's daily life. The media content may include an object, and the object may be a person, an object, or the like. How to recognize an object included in a media content is a focus of attention.

### SUMMARY

In a first aspect of the present disclosure, a method of object recognition is provided. The method includes: determining a set of first candidate object regions based on image information of a media content; determining, based on text information associated with the media content, an object region from the set of first candidate object regions; and determining an object matching the object region based on a visual feature of the object region and a text feature, the text feature being determined based on the text information.

In a second aspect of the present disclosure, an apparatus for object recognition is provided. The apparatus includes: a first determining module configured to determine a set of first candidate object regions based on image information of a media content; a second determining module configured to determine, based on text information associated with the media content, an object region from the set of first candidate object regions; and a third determining module configured to determine determining an object matching the object region based on a visual feature of the object region and a text feature, the text feature being determined based on the text information.

In a third aspect of the present disclosure, an electronic device is provided. The device includes at least one processing unit; and at least one memory coupled to the at least one processing unit and storing instructions for execution by the at least one processing unit, the instructions, when executed by the at least one processing unit, causing the electronic device to perform the method of the first aspect.

In a fourth aspect of the present disclosure, a computer-readable storage medium having a computer program stored thereon is provided. The computer program, when executed by a processor, implements the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure may be implemented;

FIG. 2 illustrates a flowchart of a process of object recognition according to some embodiments of the present disclosure;

FIG. 3 illustrates an example flowchart of object recognition according to some embodiments of the present disclosure;

FIG. 4 illustrates an example flowchart of object recognition according to some embodiments of the present disclosure;

FIG. 5 illustrates a schematic diagram of a model structure according to some embodiments of the present disclosure;

FIG. 6 is a schematic block diagram of an apparatus for object recognition according to some embodiments of the present disclosure;

FIG. 7 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth herein, but rather, these embodiments are provided for a more thorough and complete understanding of the present disclosure. It should be understood that the drawings and embodiments of the present disclosure are for example only and are not intended to limit the scope of the present disclosure.

It should be noted that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including”, and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, all data is collected, obtained, processed, processed, forwarded, used, etc., all of which are performed on the premise that the user knows and confirms. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function and does not affect the basic function of the user.

The embodiment of the invention provides a scheme of object recognition. According to the scheme, a set of first candidate object regions are determined based on image information of a media content; an object region from the set of first candidate object regions is determined based on text information associated with the media content; and an object matching the object region is determined based on a visual feature of the object region and a text feature, the text feature being determined based on the text information.

Based on this manner, embodiments of the present disclosure may recognize an object in the media content for multimodal information of the image information of the media content and text information associated with the media content, which may effectively improve the accuracy of the object recognition.

### Example Environment

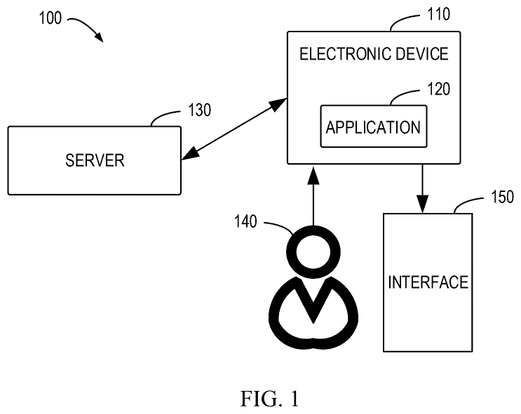

FIG. 1 illustrates a schematic diagram of an example environment 100 in which embodiments of the present disclosure may be implemented. As shown in FIG. 1, the example environment 100 may include an electronic device 110.

In the example environment 100, the electronic device 110 may run an application 120 that supports interface interaction. The application 120 may be any suitable type of application for interface interaction. The user 140 may view media contents based on the application 120, where the media content may be any suitable form of media content, such as short video, live stream video, graphics, and the like. The user 140 may interact with the application 120 via the electronic device 110 and/or its attachment device.

In the environment 100 of FIG. 1, if the application 120 is active, the electronic device 110 may present, via the application 120, an interface 150 for supporting interface interaction.

In some embodiments, the electronic device 110 communicates with a server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface (such as a “wearable” circuit, etc.) for a user.

The server 130 may be a standalone physical server, a server cluster composed of a plurality of physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide a background service for an application 120 supporting interface interaction in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (Wi-Fi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be understood that the structures and functions of the various elements in the environment 100 are described for example only and do not imply any limitation to the scope of the present disclosure.

Some example embodiments of the present disclosure will be described below with continued reference to the accompanying drawings.

### Example Processes

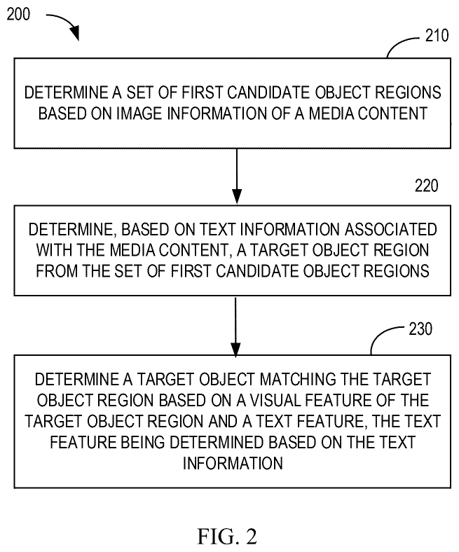

FIG. 2 illustrates a flowchart of a process 200 of object recognition according to some embodiments of the present disclosure. The process 200 may be implemented at the electronic device 110. The process 200 is described below with reference to FIG. 1.

At block 210, the electronic device 110 determines a set of first candidate object regions based on image information of a media content.

In some embodiments, the media content may be any suitable type of content such as a short video or a live stream video, and the media content includes a plurality of images. The plurality of images may include an object, and the object may be any suitable type of object such as a person or an object. As an example, the object may be a commodity.

In some embodiments, the electronic device 110 may determine a set of candidate object regions based on image information corresponding to all images in the media content.

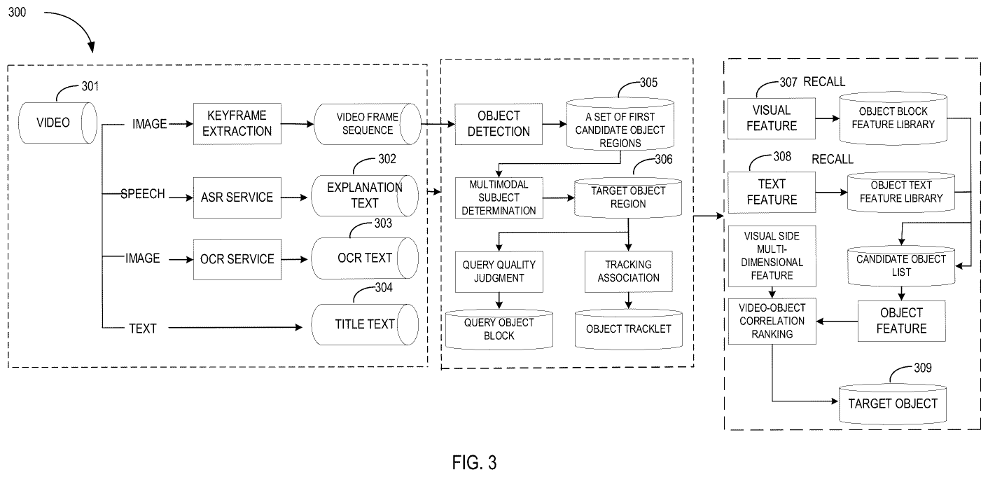

In some other embodiments, the electronic device 110 may further determine part of the keyframes from all of the images in the media content and based on image information corresponding to this part of the keyframes, determine a set of candidate object regions. Taking FIG. 3 as an example, the media content may be a video 301. The electronic device may perform keyframe extraction on the image included in the video 301 to obtain a video frame sequence, that is, the part of the keyframes. The electronic device may perform object detection based on the image information of the video frame sequence to obtain a set of first candidate object regions 305.

The candidate object region is a region corresponding to the object included in the media content in the image, and the region may be displayed in the image in the form of an object frame. The object block may be any suitable shape frame, such as a rectangular frame, an irregular shape frame, or the like, and details are not described herein again.

At block 220, the electronic device 110 determines, based on text information associated with the media content, an object region from the set of first candidate object regions.

In some embodiments, the text information associated with the media content may include, but is not limited to, at least one of: extracting a first text content from an image content of the media content; or extracting a second text content from an audio content of the media content; or determining a third text content based on description information of the media content. The description information may be a title for the media content, introduction information of an object included in the media content, and the like. The introduction information may include a type of the object, a name of the object, and the like. Taking FIG. 3 as an example, the text information associated with the media content may include an explanation text 302 obtained after speech recognition is performed on the speech included in the media content, an optical character recognition (OCR) text 303 recognized based on an image included in the media content, a title text 304 recognized based on text in the media content, and the like.

In some embodiments, the electronic device 110 may obtain the image by stitching a set of images corresponding to the set of candidate object regions, so that the image includes global information between adjacent frames or a plurality of images in the set of images. In some embodiments, the stitching manner may be any suitable stitching manner. For example, the plurality of images may be stitched into an image of N*M specifications, and N and M may be set according to requirements. The electronic device 110 may obtain the object region output by a first model by inputting the text information associated with the media content and the image into the first model. Taking FIG. 2 as an example, the electronic device 110 may perform a multimodal subject determination based on based on the explanation text 302, the OCR text 303, the title text 304, and the image to determine the object region 306. The multimodal subject determination of the present disclosure integrates the information of the text modality of the media content as well as the information of the image modality of the media content, which may effectively improve the accuracy of object recognition.

The following is an example of a training process of the first model performed by the electronic device 110. Certainly, the training process of the first model may alternatively be performed by a further device, and details are not described herein again.

To obtain the trained first model, the electronic device 110 may obtain a first training set, wherein the first training set may include a plurality of first training samples. Each first training sample may include a sample image determined by a sample video and sample text information associated with the sample video. In some embodiments, the sample image may be obtained by stitching a set of sample images, and the set of sample images may be obtained after the sample video is sampled at a predetermined sampling interval. As an example, the electronic device 110 may perform downsampling of 1 frames/2 s on the sample video to obtain the set of sample images. For each sample image in the set of sample images, the sample image is correspondingly labeled with a first label object region corresponding to a sample object included in the sample image. In some embodiments, the sample text may be an object title, a category of the object, a name of the object, or the like.

For each first training sample in the first training set, the electronic device 110 may input the first training sample in the first training set into the first model to be trained to obtain a set of predicted object regions output by the first model, and a first score corresponding to the set of predicted object regions. The electronic device 110 may reserve the predicted object region having a first score greater than a predetermined score and delete the predicted object region less than the predetermined score.

The electronic device 110 may train the first model to be trained based on a comparison between a first label object region and the reserved predicted object region. After a predetermined training condition is met, the electronic device 110 may determine to complete training of the first model. The predetermined training condition may be that a loss function reaches a minimum value, a training duration reaches a predetermined duration, and the like, and details are not described herein again.

Since the media content may include a plurality of objects, some of the plurality of objects may not be key objects in the media content. Therefore, in order to accurately recognize the key objects in the media content, the electronic device 110 may further filter out the object region including the key objects from the object region. Taking FIG. 3 as an example, the electronic device 110 may track each object included in the object region 306 and determine the object tracklet. This is, the electronic device 110 may determine the number of images corresponding to the same object in respective images corresponding to the object region, wherein the greater the number of images, the greater the probability that the object is a key object. In some embodiments, the electronic device 110 may, after determining the object region from the set of first candidate object regions, determine whether the number of images corresponding to the same object in respective images corresponding to the object region is greater than a predetermined number. The electronic device 110 may, in response to the number of images corresponding to the same object being less than or equal to a predetermined number, delete the object region corresponding to the image of the same object of this object. For example, if there are 2 images including object A in each image corresponding to the object region, and there are objects including 10 objects B, the electronic device 110 may delete the object region corresponding to the image containing the object A to ensure that the object A is not object recognized by the subsequent electronic device 110.

Since some images may contain objects that are obscured, or the object recognition is not obvious due to the shooting angle, etc., in order to improve the accuracy of the object recognition in the media content, taking FIG. 3 as an example, the electronic device 110 may perform a query quality judgment to determine a query object block. That is, the electronic device 110 may, after determining the object region 306 from the set of first candidate object regions, determine whether a quality corresponding to the object region 306 is greater than a predetermined quality. The electronic device 110 may, in response to the quality corresponding to the object region 306 being lower than or equal to a predetermined quality, delete the object region in order to filter the object region that reduces the accuracy of the object recognition.

At block 230, the electronic device 110 determines an object matching the object region based on a visual feature of the object region and a text feature, the text feature being determined based on the text information.

In some embodiments, to filter out noise information in the text information to improve the accuracy of object recognition, the electronic device 110 may determine the textual feature based on the textual information before determining an object matching the object region based on a visual feature of the object region and a text feature.

As an example, the electronic device 110 may obtain the text feature output by a third model by inputting the text information into the third model, wherein the text feature is a structured description feature generated based on the text information filtered out of the noise information.

As a further example, the electronic device 110 may obtain a set of candidate images associated with the text information, wherein a time interval between a first time when the set of candidate images appears in the media content and a second time when the text information appears in the media content is less than a predetermined interval. The electronic device 110 may determine the set of candidate images as a prompt and obtain the text feature output by the third model by inputting the text information and the prompt into the third model.

Taking FIG. 3 as an example, the electronic device may perform one way object recall based on a visual feature 307 of the object region and an object block feature library and perform one way object recall based on a text feature 308 and an object text feature, and finally determine the object based on the two recalled objects.

In some embodiments, when performing one way object recall based on the text feature and the object text feature, the electronic device 110 may determine a first candidate object based on a comparison of the text feature and each feature in the text feature library. As an example, the electronic device 110 may determine a first similarity between the text feature and each feature in the text feature library. The electronic device 110 may determine, as the first candidate object, an object corresponding to a feature whose first similarity is greater than a predetermined similarity in the text feature library.

In some embodiments, when performing one way object recall based on the visual feature of the object region and the object block feature library, the electronic device 110 may determine a second candidate object based on a comparison result of the visual feature of the object region and each feature in the feature library corresponding to the object region. As an example, the electronic device 110 may determine a second similarity between the visual feature of the object region and each feature in the feature library corresponding to the object region. The electronic device 110 may determine, as the second candidate object, the object whose second similarity is greater than the predetermined similarity in the feature library corresponding to the object region.

In some embodiments, the electronic device 110 may determine a object matching the object region based on the first candidate object and the second candidate object.

As an example, the electronic device 110 may determine whether the first candidate object is the same as the second candidate object to determine a same candidate object as the object matching the object region.

As a further example, when determining the object based on the two recalled objects, the electronic device 110 may determine a set of fourth candidate objects matching the object region based on the first candidate object and the second candidate object. In some embodiments, the electronic device 110 may obtain the object features corresponding to the set of fourth candidate objects. Taking FIG. 3 as an example, the electronic device 110 may perform a video-object correlation ranking on the set of fourth candidate objects based on the object features and the visual side multi-dimensional features, and finally determine the object 309 based on the ranking result. In some embodiments, the electronic device 110 may input the text information, the image information, and the object features corresponding to the set of the fourth candidate objects into the fourth model to determine the similarity corresponding to the set of the fourth candidate objects, and the higher the similarity corresponding to the fourth candidate object, the greater the probability that the fourth candidate object corresponds to the object. The electronic device 110 may determine the object based on the similarity of the set of second candidate objects. As an example, the electronic device 110 may determine a fourth candidate object with a largest similarity among the set of fourth candidate objects as the object. As a further example, the electronic device 110 may determine a fourth candidate object whose similarity is greater than a predetermined similarity among the set of fourth candidate objects as the object.

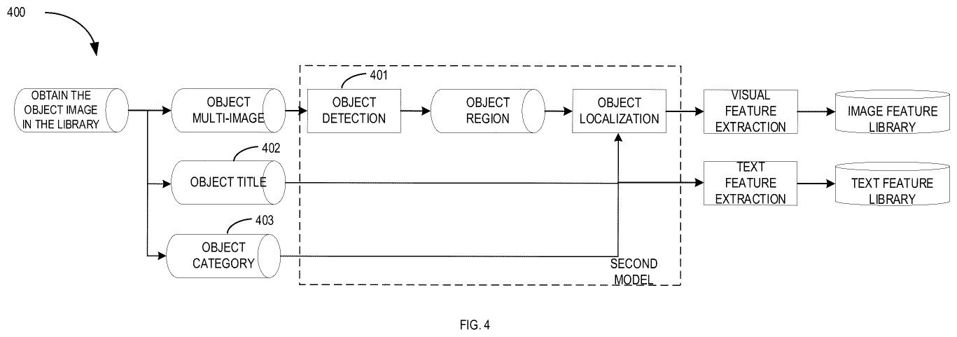

Taking FIG. 4 as an example, the process of determining each feature in the text feature library and each feature in the feature library corresponding to the object region is described below.

In some embodiments, the electronic device 110 may store each object image, so that the electronic device may obtain the object image in the object library.

The electronic device 110 may obtain a second candidate object region output by the second model by inputting the object image in the object library and text information associated with image information of the object image into a second model. The text information associated with the image information of the object image may be a name of the object, a category of the object, and the like. Taking FIG. 4 as an example, the electronic device may input an object multi-image, an object title, and an object category into the second model. The electronic device may perform object detection 401 on the object multi-image with the second model to obtain an object region in the object multi-image. The electronic device may perform object localization with the object region, the object title 402 and the object category 403 to obtain a second candidate object region output by the second model. The electronic device 110 may determine a visual feature of the second candidate object region. The electronic device 110 may determine, based on the visual feature of the second candidate object region, a feature in a feature library corresponding to the object region, that is, determine the feature in the image feature library.

To obtain the trained second model, the electronic device 110 may obtain a second training set including a plurality of second training samples, and each second training sample may include a sample image corresponding to the sample object and a sample text corresponding to the sample object. For each sample image, the sample image correspondingly labels a second labeled object region of the sample object in the sample image. The sample text may be an object title, a category of the object, a name of the object, and the like. For each second training sample, the electronic device 110 may input the second training sample into the second model to be trained to obtain a set of predicted object regions output by the second model, and a second score corresponding to the set of predicted object regions. The electronic device 110 may reserve the predicted object region with the second score greater than the predetermined score and delete the predicted object region with the second score less than the predetermined score.

The electronic device 110 may train the second model to be trained based on a comparison between a second label object region and the reserved predicted object region. After a predetermined training condition is met, the electronic device 110 may determine to complete training of the second model. The predetermined training condition may be that a loss function reaches a minimum value, a training duration reaches a predetermined duration, and the like, and details are not described herein again.

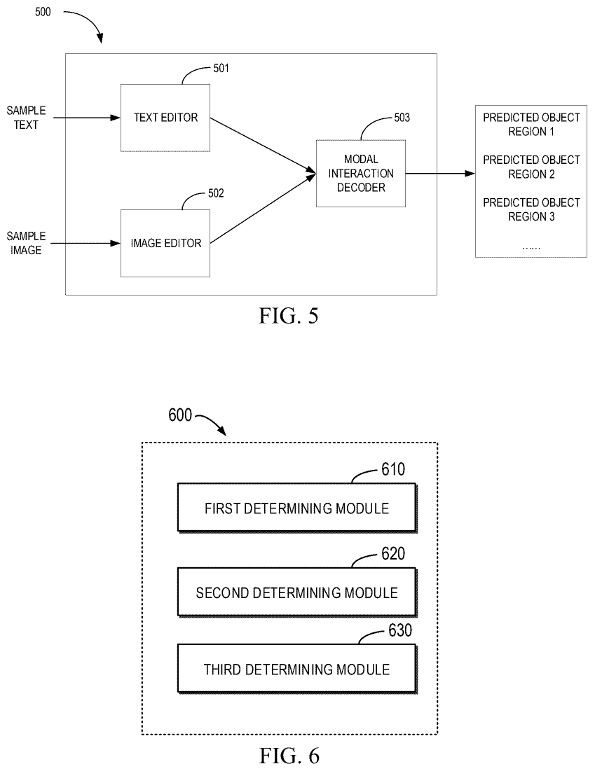

Taking FIG. 5 as an example, the second model may include a text editor 501, an image editor 502, and a modal interaction decoder 503. The text encoder 501 is configured to obtain a text representation corresponding to the sample text, and the image editor 502 is configured to obtain an image representation corresponding to the sample image. The modal interaction decoder 503 is configured to comprehensively predict, based on the text representation and the image representation, the set of predicted object regions corresponding to the sample image input into the second model.

In some embodiments, the electronic device 110 may determine a text feature of a third candidate object comprised in the object image based on the text information associated with the image information of the object image. In some embodiments, the electronic device 110 may obtain the text feature of the third candidate object included in a third model output object image by inputting the text information associated with the image information of the object image into the third model, wherein the text feature of the third candidate object is a structured description feature of the filtered noise information generated by the text information associated with the image information of the object image. The electronic device 110 may determine each feature in the text feature library based on the text feature of the third candidate object., that is, determine a feature in the text feature library.

The process of obtaining the visual feature of the object region is described below.

In some embodiments, before determining an object matching the object region based on a text feature and a visual feature of the object region, the electronic device 110 may obtain a visual feature of the object region output by a visual feature model by inputting an image corresponding to the object region into the visual feature model. In some embodiments, the visual feature model may adopt a convolutional network or an attention mechanism converter to extract a visual feature of an image corresponding to an object region input into the visual feature model.

In some embodiments, to obtain the trained visual feature model, the electronic device 110 may obtain a training set, and train the visual feature model based on the training set. In some embodiments, the electronic device 110 may determine a set of first sample images from a sample video and determine a second sample image from an object library, wherein the first sample image and the second sample image include sample objects. The sample video may be a video collected in a real scene. The image included in the object library may be an image including an object in a non-real scene, for example, may be a rendered image, a generated image, or the like. The electronic device 110 may determine the set of first sample images and the second sample image as a first candidate sample image pair, wherein each image in the first candidate sample image pair is labeled with an object region. The electronic device 110 may determine a first similarity between a first feature corresponding to an object region in the set of first sample images and a second feature corresponding to the second sample image. To ensure that the object has a uniform representation in the real scene and the non-real scene, the electronic device 110 may add a first candidate sample image pair to the training set, a first similarity of the first candidate sample image being less than a first threshold and greater than a second threshold.

In some embodiments, after determining a set of first sample images from a sample video, the electronic device 110 may determine the set of first sample images and a feedback image as a second candidate sample image pair, where each image in the second candidate sample image pair is labeled with an object region, the feedback image being an image obtained for the sample video that is associated with an object comprised in the sample video. The feedback image may be an image related to an object contained in this sample video that is commented on by the respective user viewing the sample video. For example, the electronic device 110 may receive other images including the object B sent in the comment region of the video after the user A views the video containing the object B. The electronic device 110 may determine a third feature corresponding to an object region in the feedback image and determine a second similarity between a first feature corresponding to an object region in the set of first sample images and the third feature. The electronic device 110 may add a second candidate sample image pair to the training set, a second similarity of the second candidate sample image pair being less than a first threshold and greater than a second threshold.

After obtaining the training set, the electronic device 110 may train the visual feature model to be trained based on the training set. In some embodiments, the visual feature model may include a cross-domain alignment module configured to implement alignment between a video domain and an object domain or may be referred to as alignment of the same object in a real scene and a non-real scene. In some embodiments, the electronic device 110 may determine a ternary contrast loss function to train the visual feature model to be trained based on the ternary contrast loss function, wherein the ternary may include an anchor point, a positive sample point, and a negative sample point. In embodiments of the present disclosure, the anchor point may be an image in a non-real scene, i.e., an image in an object library, the positive sample point and the negative sample point are images in a real scene, i.e., an image in a sample video. In the process of training the visual feature model, the feature distance between the anchor point and the positive sample may be brought closer, and the feature distance between the anchor point and the negative sample may be pulled further. As an example, the electronic device 110 may determine that training of the visual feature model to be trained is completed when a value of the ternary contrast loss function is determined to be a minimum.

Based on this manner, the embodiments of the present disclosure may recognize an object in the media content for multimodal information of the image information of the media content and text information associated with the media content, which may effectively improve the accuracy of the object recognition.

### Example Apparatus and Device

Embodiments of the present disclosure also provide a corresponding apparatus for implementing the above method or process. FIG. 6 illustrates a schematic structural block diagram of an apparatus 600 for providing a media content according to some embodiments of the present disclosure. The apparatus 600 may be implemented or included in the electronic device 110 as discussed above. The various modules/components in the apparatus 600 may be implemented by hardware, software, firmware, or any combination thereof.

As shown in FIG. 6, the apparatus 600 includes a first determining module 610 configured to determine a set of first candidate object regions based on image information of a media content; a second determining module 620 configured to determine, based on text information associated with the media content, an object region from the set of first candidate object regions; and a third determining module 630 configured to configured to determine determining an object matching the object region based on a visual feature of the object region and a text feature, the text feature being determined based on the text information.

In some embodiments, the second determining module 620 is specifically configured to an image by stitching a set of images corresponding to the set of first candidate object regions; and obtain the object region output by a first model by inputting the image and text information associated with the media content into the first model.

In some embodiments, the apparatus 600 further includes a fourth determining module configured to: determine whether a number of images corresponding to a same object in each image corresponding to the object region is greater than a predetermined number; and a first deleting module configured to, in response to the number of images corresponding to the same object being less than or equal to the predetermined number, delete the object region corresponding to the image of the same object.

In some embodiments, the apparatus 600 further includes a fifth determining module configured to: determine whether a quality corresponding to the object region is better than a predetermined quality; and a second deleting module configured to, in response to the quality of the object region being lower than or equal to the predetermined quality, delete the object region.

In some embodiments, the third determining module 630 is specifically configured to: determine a first candidate object based on a comparison result of the text feature and each feature in a text feature library; determine a second candidate object based on a comparison result of the visual feature of the object region and each feature in a feature library corresponding to the object region; and determine a object matching the object region based on the first candidate object and the second candidate object.

In some embodiments, the apparatus 600 further includes a first obtaining module configured to obtain an object image in an object library; a second obtaining module configured to obtain a second candidate object region output by the second model by inputting the object image in the object library and text information associated with image information of the object image into a second model; a sixth determining module configured to determine a visual feature of the second candidate object region; and a seventh determining module configured to determine, based on the visual feature of the second candidate object region, a feature in a feature library corresponding to the object region.

In some embodiments, the apparatus 600 further includes an eighth determining module configured to: determine a text feature of a third candidate object comprised in the object image based on the text information associated with the image information of the object image; and a ninth determining module configured to determine each feature in the text feature library based on the text feature of the third candidate object.

In some embodiments, the apparatus 600 further includes a third obtaining module configured to obtain the text feature output by a third model by inputting the text information into the third model, wherein the text feature is a structural description feature generated based on the text information.

In some embodiments, the third obtaining module is specifically configured to obtain a set of candidate images associated with the text information, wherein a time interval between a first time when the set of candidate images appears in the media content and a second time when the text information appears in the media content is less than a predetermined interval; determine the set of candidate images as a prompt; and obtain the text feature output by the third model by inputting the text information and the prompt into the third model.

In some embodiments, the third determining module is specifically configured to determine, based on a text feature and a visual feature of the object region, a set of fourth candidate objects matching the object region; obtain an object feature corresponding to the set of fourth candidate objects; determine a similarity corresponding to the set of fourth candidate objects by inputting the text information, the image information, and the object feature corresponding to the set of fourth candidate objects into a fourth model; and determine the object based on the similarity corresponding to the set of second candidate objects.

In some embodiments, the text information comprise at least one of the following: a first text content extracted from an image content of the media content; a second text content extracted from an audio content of the media content; or a third text content determined based on description information of the media content.

In some embodiments, the apparatus 600 further includes a fourth obtaining module configured to obtain a visual feature of the object region output by a visual feature model by inputting an image corresponding to the object region into the visual feature model.

In some embodiments, the apparatus 600 further includes a tenth determining module configured to: determine a set of first sample images from a sample video, wherein a first sample image comprises a sample object; an eleventh determining module configured to: determine a second sample image comprising the sample object from an object library; determine the set of first sample images and the second sample image as a first candidate sample image pair, wherein each image in the first candidate sample image pair is labeled with an object region; an eleventh determining module configured to: determine a first similarity between a first feature corresponding to an object region in the set of first sample images and a second feature corresponding to the second sample image; and an adding module configured to: add a first candidate sample image pair to the training set, a first similarity of the first candidate sample image being less than a first threshold and greater than a second threshold.

In some embodiments, the apparatus 600 further includes a fifth obtaining module configured to: obtain a feedback image for the sample video, the feedback image being an image obtained for the sample video that is associated with an object comprised in the sample video; a twelfth determining module configured to: determine the set of first sample images and a feedback image as a second candidate sample image pair, where each image in the second candidate sample image pair is labeled with an object region; a thirteenth determining module configured to: determine a third feature corresponding to an object region in the feedback image; a fourteenth determining module configured to: determine a second similarity between a first feature corresponding to an object reg ion in the set of first sample images and the third feature; and a second adding module configured to: add a second candidate sample image pair to the training set, a second similarity of the second candidate sample image pair being less than a first threshold and greater than a second threshold.

The units included in the apparatus 600 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the elements in the apparatus 600 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

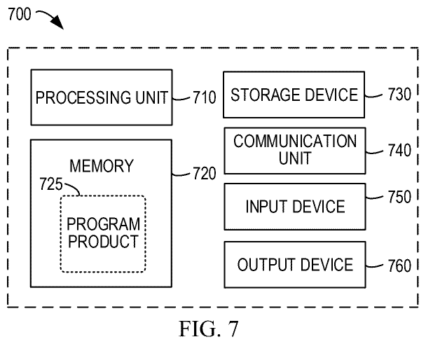

FIG. 7 illustrates a block diagram of an electronic device 700 in which one or more embodiments of the present disclosure may be implemented. It should be understood that the electronic device 700 illustrated in FIG. 7 is merely for example and should not constitute any limitation on the functionality and scope of the embodiments described herein. The electronic device 700 shown in FIG. 7 may be configured to implement the electronic device 110 shown in FIG. 1.

As shown in FIG. 7, the electronic device 700 is in the form of a general-purpose electronic device. Components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in the memory 720. In multiprocessor systems, a plurality of processing units execute computer-executable instructions in parallel to improve a parallel processing capability of electronic device 700.

Electronic device 700 typically includes a plurality of computer storage media. Such media may be any accessible media accessible to the electronic device 700, including, but not limited to, volatile and non-volatile media, removable and non-removable media. The memory 720 may be volatile memory (e.g., registers, cache, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium, such as a flash drive, a disk, or any other medium, which may be capable of being used to store information and/or data (e.g., training data for training purposes) and be accessible within the electronic device 700.

The electronic device 700 may further include additional removable/non-removable, volatile/non-volatile storage media. Although not shown in FIG. 7, a disk drive for reading from or writing to a removable, non-volatile disk (e.g., a “floppy disk”) and an optical disk drive for reading from or writing to a removable, non-volatile optical disk may be provided. In these embodiments, each drive may be connected to a bus (not shown) by one or more data media interfaces. The memory 720 may include a computer program product 725 having one or more program modules that are configured to perform various methods or actions of various embodiments of the present disclosure.

The communication unit 740 is configured to communicate with a further electronic device through a communication medium. Additionally, the functionality of components of the electronic device 700 may be implemented in a single computing cluster or a plurality of computing machines capable of communicating over a communication connection. Thus, the electronic device 700 may operate in a networked environment using logical connections with one or more other servers, network personal computers (PCs), or a further network node.

The input device 750 may be one or more input devices such as a mouse, a keyboard, a trackball, or the like. The output device 760 may be one or more output devices, such as a display, a speaker, a printer, and the like. The electronic device 700 may also communicate, as desired, via the communication unit 740, with one or more external devices (not shown), external devices such as storage devices, display devices, etc., with one or more devices that enable a user to interact with the electronic device 700, or with any device that enables the electronic device 700 to communicate with one or more other electronic devices (e.g., a network card, modem, etc.) to communicate. Such communication may be performed via an input/output (I/O) interface (not shown).

According to example implementations of the present disclosure, there is provided a computer-readable storage medium having computer-executable instructions stored thereon, wherein the computer-executable instructions, when executed by a processor, implements the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to the processing unit of a general-purpose computer, a special-purpose computer, or other programmable data-processing device, thereby producing a machine such that the instructions, when performed through the processing unit of the computer or other programmable data-processing device, produce a device that carries out the functions/actions set forth in one or more of the blocks in the flowchart and/or block diagram. It is also possible to store these computer-readable program instructions in a computer-readable storage medium that causes the computer, programmable data processing device, and/or other device to function in a particular manner, whereby the computer-readable medium with the instructions stored then comprises an article of manufacture that includes instructions for implementing aspects of the functions/actions specified in the flowchart and/or one or more of the blocks in the block diagram.

Computer-readable program instructions may be loaded onto a computer, other programmable data processing device, or other device such that a series of operational steps are performed on the computer, other programmable data processing device, or other device to produce a computer-implemented process such that the instructions performed on the computer, other programmable data processing device, or other device perform one of the flowchart and/or block diagrams or a plurality of blocks to perform the function/action specified in the flowchart and/or the block diagram.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are example, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, the practical application, or improvements to the technology in the marketplace, or to enable others of ordinary skill in the art to understand the various implementations disclosed herein.

1. A method of object recognition, comprising:
determining a set of first candidate object regions based on image information of a media content;
determining, based on text information associated with the media content, an object region from the set of first candidate object regions; and
determining an object matching the object region based on a visual feature of the object region and a text feature, the text feature being determined based on the text information.

2. The method of claim 1, wherein determining, based on text information associated with the media content, an object region from the set of first candidate object regions comprises:
obtaining an image by stitching a set of images corresponding to the set of first candidate object regions; and
obtaining the object region output by a first model by inputting the image and text information associated with the media content into the first model.

3. The method of claim 1, after determining an object region from the set of first candidate object regions, the method further comprising:
determining whether a number of images corresponding to a same object in each image corresponding to the object region is greater than a predetermined number; and
in response to the number of images corresponding to the same object being less than or equal to the predetermined number, deleting the object region corresponding to the image of the same object.

4. The method of claim 1, after determining an object region from the set of first candidate object regions, the method further comprising:
determining whether a quality corresponding to the object region is better than a predetermined quality; and
in response to the quality of the object region being lower than or equal to the predetermined quality, deleting the object region.

5. The method of claim 1, wherein determining an object matching the object region based on a text feature and a visual feature of the object region comprises:
determining a first candidate object based on a comparison result of the text feature and each feature in a text feature library;
determining a second candidate object based on a comparison result of the visual feature of the object region and each feature in a feature library corresponding to the object region; and
determining an object matching the object region based on the first candidate object and the second candidate object.

6. The method of claim 5, wherein each feature in a feature library corresponding to the object region is determined through:
obtaining an object image in an object library;
obtaining a second candidate object region output by the second model by inputting the object image in the object library and text information associated with image information of the object image into a second model;
determining a visual feature of the second candidate object region; and
determining, based on the visual feature of the second candidate object region, a feature in a feature library corresponding to the object region.

7. The method of claim 6, wherein each feature in the text feature library is determined through:
determining a text feature of a third candidate object comprised in the object image based on the text information associated with the image information of the object image; and
determining each feature in the text feature library based on the text feature of the third candidate object.

8. The method of claim 1, before determining an object matching the object region based on a text feature and a visual feature of the object region, the method further comprising:
obtaining the text feature output by a third model by inputting the text information into the third model, wherein the text feature is a structural description feature generated based on the text information.

9. The method of claim 8, wherein obtaining the text feature output by a third model by inputting the text information into the third model comprises:
obtaining a set of candidate images associated with the text information, wherein a time interval between a first time when the set of candidate images appears in the media content and a second time when the text information appears in the media content is less than a predetermined interval;
determining the set of candidate images as a prompt; and
obtaining the text feature output by the third model by inputting the text information and the prompt into the third model.

10. The method of claim 1, wherein determining an object matching the object region based on a text feature and a visual feature of the object region comprises:
determining, based on a text feature and a visual feature of the object region, a set of fourth candidate objects matching the object region;
obtaining an object feature corresponding to the set of fourth candidate objects;
determining a similarity corresponding to the set of fourth candidate objects by inputting the text information, the image information, and the object feature corresponding to the set of fourth candidate objects into a fourth model; and
determining the object based on the similarity corresponding to the set of second candidate objects.

11. The method of claim 1, wherein the text information comprise at least one of the following:
a first text content extracted from an image content of the media content;
a second text content extracted from an audio content of the media content; or
a third text content determined based on description information of the media content.

12. The method of claim 1, before determining an object matching the object region based on a text feature and a visual feature of the object region, the method further comprising:
obtaining a visual feature of the object region output by a visual feature model by inputting an image corresponding to the object region into the visual feature model.

13. The method of claim 12, wherein a training set for training the visual feature model is determined through:
determining a set of first sample images from a sample video, wherein a first sample image comprises a sample object;
determining a second sample image comprising the sample object from an object library;
determining the set of first sample images and the second sample image as a first candidate sample image pair, wherein each image in the first candidate sample image pair is labeled with an object region;
determining a first similarity between a first feature corresponding to an object region in the set of first sample images and a second feature corresponding to the second sample image; and
adding a first candidate sample image pair to the training set, a first similarity of the first candidate sample image being less than a first threshold and greater than a second threshold.

14. The method of claim 13, after determining a set of first sample images from a sample video, the method further comprising:
determining the set of first sample images and a feedback image as a second candidate sample image pair, where each image in the second candidate sample image pair is labeled with an object region, the feedback image being an image obtained for the sample video that is associated with an object comprised in the sample video;
determining a third feature corresponding to an object region in the feedback image;
determining a second similarity between a first feature corresponding to an object region in the set of first sample images and the third feature; and
adding a second candidate sample image pair to the training set, a second similarity of the second candidate sample image pair being less than a first threshold and greater than a second threshold.

15. An electronic device, comprising:
at least one processing unit; and
at least one memory coupled to the at least one processing unit and storing instructions for execution by the at least one processing unit, the instructions, when executed by the at least one processing unit, causing the electronic device to implements operations comprising:
determining a set of first candidate object regions based on image information of a media content;
determining, based on text information associated with the media content, an object region from the set of first candidate object regions; and
determining an object matching the object region based on a visual feature of the object region and a text feature, the text feature being determined based on the text information.

16. The electronic device of claim 15, wherein determining, based on text information associated with the media content, an object region from the set of first candidate object regions comprises:
obtaining an image by stitching a set of images corresponding to the set of first candidate object regions; and
obtaining the object region output by a first model by inputting the image and text information associated with the media content into the first model.

17. The electronic device of claim 15, after determining an object region from the set of first candidate object regions, the operations further comprising:
determining whether a number of images corresponding to a same object in each image corresponding to the object region is greater than a predetermined number; and
in response to the number of images corresponding to the same object being less than or equal to the predetermined number, deleting the object region corresponding to the image of the same object.

18. The electronic device of claim 15, after determining an object region from the set of first candidate object regions, the operations further comprising:
determining whether a quality corresponding to the object region is better than a predetermined quality; and
in response to the quality of the object region being lower than or equal to the predetermined quality, deleting the object region.

19. The electronic device of claim 15, wherein determining an object matching the object region based on a text feature and a visual feature of the object region comprises:
determining a first candidate object based on a comparison result of the text feature and each feature in a text feature library;
determining a second candidate object based on a comparison result of the visual feature of the object region and each feature in a feature library corresponding to the object region; and
determining an object matching the object region based on the first candidate object and the second candidate object.

20. A non-transitory computer readable storage medium having a computer program stored thereon, the computer program, when executed by a processor, implementing operations comprising:
determining a set of first candidate object regions based on image information of a media content;
determining, based on text information associated with the media content, an object region from the set of first candidate object regions; and
determining an object matching the object region based on a visual feature of the object region and a text feature, the text feature being determined based on the text information.
